(19) United States
(12) Patent Application Publication
(10) Pub. No.: US 2019/0324677 A1
(43) Pub. Date: Oct. 24, 2019

(54) INFORMATION PROCESSING APPARATUS

(71) Applicant: FUJITSU LIMITED, Kawasaki-shi (JP)

(72) Inventor: Kazuichi Oe, Yokohama (JP)

(73) Assignee: FUJITSU LIMITED, Kawasaki-shi (JP)

(21) Appl. No.: 16/381,031

(22) Filed: Apr. 11, 2019

(30) Foreign Application Priority Data
Apr. 24, 2018 (JP) 2018-083295

(51) Int. Cl. G06F 3/06

(52) U.S. Cl. CPC G06F 3/0647; G06F 3/0685; G06F 3/0604

(57) ABSTRACT

A method for data migration between a first storage device and a second storage device whose performance is different from that of the first storage device, the method includes: executing comparison processing that includes comparing a first projected effect in a case of migrating data in an access concentration area of the second storage device to the first storage device and a second projected effect in a case of storing in the first storage device a copy of data in the second storage device and using the copy of data as cached data without migrating the data, and executing determination processing that includes determining to migrate data in a first area of the second storage device to the first storage device when the first projected effect is greater than the second projected effect, the first area being the access concentration area of the second storage device.

### CROSS-REFERENCE TO RELATED APPLICATION

This application is based upon and claims the benefit of priority of the prior Japanese Patent Application No. 2018-83295, filed on Apr. 24, 2018, the entire contents of which are incorporated herein by reference.

### FIELD

The embodiment discussed herein is related to an information processing apparatus.

### BACKGROUND

As a storage system for storing data, a hierarchical storage system, which integrates multiple storage media (storage devices), is used in some cases. As examples of the multiple storage media, a solid state drive (SSD), which is capable of high-speed access but has relatively smaller capacity with higher cost, and a hard disk drive (HDD), which has larger capacity with lower cost but is a slower device, may be used. In such a hierarchical storage system, the SSD is also referred to as the tiering SSD.

In the hierarchical storage system, less frequently accessed data is stored in the HDD whereas frequently accessed data is stored in the tiering SSD. This configuration improves the efficiency of use of the tiering SSD, consequently improving the efficiency of the entire system. Accordingly, to enhance the performance of the hierarchical storage system, it is desired to efficiently store frequently accessed data in the tiering SSD.

A known technology stores in the tiering SSD, for example, data that is frequently accessed on the daily basis, where the frequently accessed data is determined in accordance with the access frequency on the previous day.

In such a hierarchical storage system, the tiering SSD processes concentrated input/output (IO) accesses whereas the HDD processes non-concentrated IO accesses.

The storage area of the tiering SSD is, for example, statically designated when the system is initialized and used when IO access concentration occur.

Examples of the related art include International Publication Pamphlet No. WO2015/114809 and Japanese Laid-open Patent Publication No. 2016-184326.

### SUMMARY

According to an aspect of the embodiments, a method for data migration between a first storage device and a second storage device whose performance is different from that of the first storage device, the method includes: executing comparison processing that includes comparing a first projected effect in a case of migrating data in an access concentration area of the second storage device to the first storage device and a second projected effect in a case of storing in the first storage device a copy of data in the second storage device and using the copy of data as cached data without migrating the data, and executing determination processing that includes determining to migrate data in a first area of the second storage device to the first storage device when the first projected effect is greater than the second projected effect, the first area being the access concentration area of the second storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional configuration of a hierarchical storage system as an example of an embodiment;

FIG. 2 illustrates an IO access concentration state in a storage area of a HDD;

FIG. 3 exemplifies a bitmap counter of the hierarchical storage system as an example of the embodiment;

FIG. 4 is a diagram for describing processing performed by an IO access concentration determination unit of the hierarchical storage system as an example of the embodiment;

FIG. 5 exemplifies a sub-logical unit number (sub-LUN) caching information of the hierarchical storage system as an example of the embodiment;

FIG. 6 illustrates an example of a hardware configuration of the hierarchical storage control apparatus illustrated in FIG. 1;

FIG. 7 is a flowchart for describing processing performed by a hierarchical manager of the hierarchical storage system as an example of the embodiment;

FIG. 8 is a flowchart for describing processing performed by an IO access concentration determination unit of a cache driver of the hierarchical storage system as an example of the embodiment; and

FIG. 9 is another flowchart for describing the processing performed by the IO access concentration determination unit of the cache driver of the hierarchical storage system as an example of the embodiment.

### DESCRIPTION OF EMBODIMENTS

However, in the hierarchical storage system, the IO access concentration do not consistently occur, and thus, the previously designated storage area of the tiering SSD is not consistently used.

Therefore, the known hierarchical storage system has a problem of less efficiently used storage area of the tiering SSD.

In one aspect, the object of the present embodiment is to efficiently use a storage device.

An embodiment of an information processing apparatus, an information processing method, and a program is described below with reference to the drawings. It is noted that the embodiment described below is a mere example and not intended to exclude the application of various modification and technologies not denoted in the embodiment. In other words, various modifications of this embodiment are implemented without departing from the scope of the embodiment. Furthermore, the drawings are not intended to indicate that only the constituent elements illustrated therein are included and may include other functions.

<A. Configuration>

<A-1. Functional Configuration Example of Hierarchical Storage Control Apparatus>

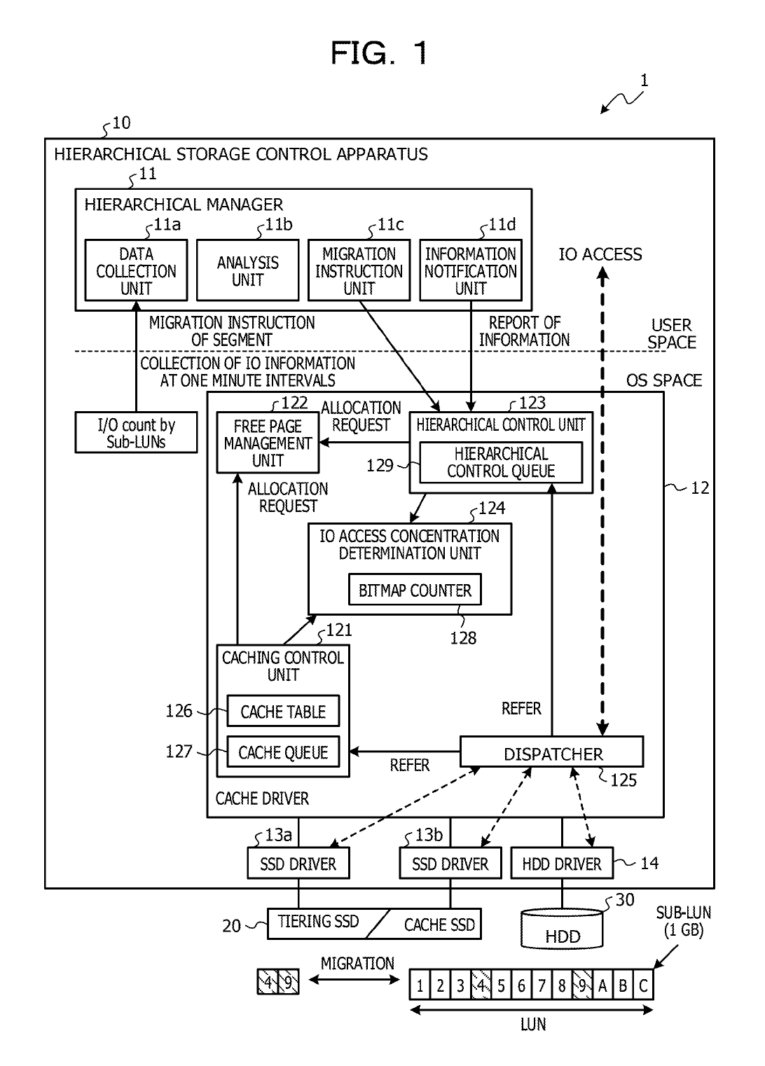

FIG. 1 illustrates an example of a functional configuration of the hierarchical storage system 1 as an example of the embodiment. As illustrated in FIG. 1, the hierarchical storage system 1 includes, for example, a hierarchical storage control apparatus 10, at least one (one in FIG. 1) SSD 20, and at least one (one in FIG. 1) HDD 30.

The hierarchical storage system 1 is an example of a storage apparatus integrating multiple storage devices. The hierarchical storage system 1 is equipped with multiple storage devices with different performances, such as the SSD 20 and the HDD 30, and provides the storage area constituted by tiered storage devices for a host device not illustrated in the drawing. As an example, the hierarchical storage system 1 may provide for the host device, by employing the redundant arrays of inexpensive disks (RAID) technology, one or more storage volumes of logical units identified by logical unit numbers (LUNs) based on a RAID group, in which data is stored in the multiple storage devices in a distributed or redundant manner.

The hierarchical storage control apparatus (an information processing apparatus) 10 performs various kinds of access, such as read and write access, to the SSD 20 and the HDD 30 in response to an IO request from, for example, the host device via a network. Examples of the hierarchical storage control apparatus 10 include an information processing apparatus (a computer), such as a personal computer (PC), a server, or a controller module (CM).

The hierarchical storage control apparatus 10 according to the embodiment performs the dynamic hierarchical control in which the area for data with lower access frequency is allocated in the HDD 30 whereas the area for data with higher access frequency is allocated in the SSD 20 in accordance with the access frequency of IO requests. This dynamic hierarchical control is also referred to as on-the-fly automated storing tiering (OTF-AST). The hierarchical storage control apparatus 10 is an example of an information processing apparatus that migrates multiple segments (unit areas) of data between the SSD 20 and the HDD 30.

The hierarchical storage control apparatus 10 may use the function of the device mapper, which is a module (a program) implemented in Linux (registered trademark). For example, in the dynamic hierarchical control, the hierarchical storage control apparatus 10 monitors the storage volume with respect to each segment unit (each logical unit identified by a sub-LUN) by using the device-mapper and accordingly migrates the data in a segment under a high load condition from the HDD 30 to the SSD 20, thereby dealing with IO operations for a segment under a high load condition.

Here, the segment is an area obtained by dividing a storage volume by a predetermined size and is the smallest unit of area (a unit area) used in the hierarchical migration of the dynamic hierarchical control. The segment has the size of, for example, 1 gigabyte (GB).

The SSD 20 is an example of a storage device for storing, for example, various kinds of data and programs. The HDD 30 is an example of a storage device with the performance (for example, slow performance) different from that of the SSD 20. In the embodiment, a semiconductor drive, such as the SSD 20, and a magnetic disk drive, such as the HDD 30, are used as examples of storage devices different from each other (for ease of description, hereinafter also referred to as first and second storage devices), however, the storage devices are not limited to these examples. As the first and second storage devices, various storage devices with different performances, for example, different read/write speeds may be used.

The SSD 20 and the HDD 30 each have a storage area capable of storing data in segments of the storage volume. The hierarchical storage control apparatus 10 controls the migration of data between the storage area of the SSD 20 and the storage area of the HDD 30 with respect to each segment unit.

The hierarchical storage system 1 includes the single SSD 20 and the single HDD 30 in the example in FIG. 1 but may include multiple SSDs 20 and multiple HDDs 30.

In the following description, the SSD 20 is also referred to as the tiering SSD 20 when the data of a segment under a high load condition is migrated from the HDD 30 to the SSD 20 under the dynamic hierarchical control described above.

In the hierarchical storage system 1, the SSD 20 is also capable of being used as the cache of the HDD 30. When the SSD 20 is used as the cache, the SSD 20 is also referred to as the cache SSD 20.

Hereinafter, an example of a functional configuration of the hierarchical storage control apparatus 10 is described. As illustrated in FIG. 1, the hierarchical storage control apparatus 10 includes, for example, a hierarchical manager 11, a cache driver 12, SSD drivers 13a and 13b, and a HDD driver 14. The hierarchical manager 11 may be implemented by running a program in the user space. The cache driver 12, the SSD drivers 13a and 13b, and the HDD driver 14 may be implemented by running a program in the operating system (OS) space.

The hierarchical manager 11 determines a segment to be migrated to another storage area in accordance with IO information obtained by performing tracing of IOs in the storage volume and instructs the cache driver 12 to move the data of the determined segment. For the IO tracing, the command blktrace, which is used for collecting IO traces in the block IO layer, may be used. Instead of blktrace, the command iostat, which is used for monitoring IO operations for disks, may be used. Both blktrace and iostat are executed in the OS space.

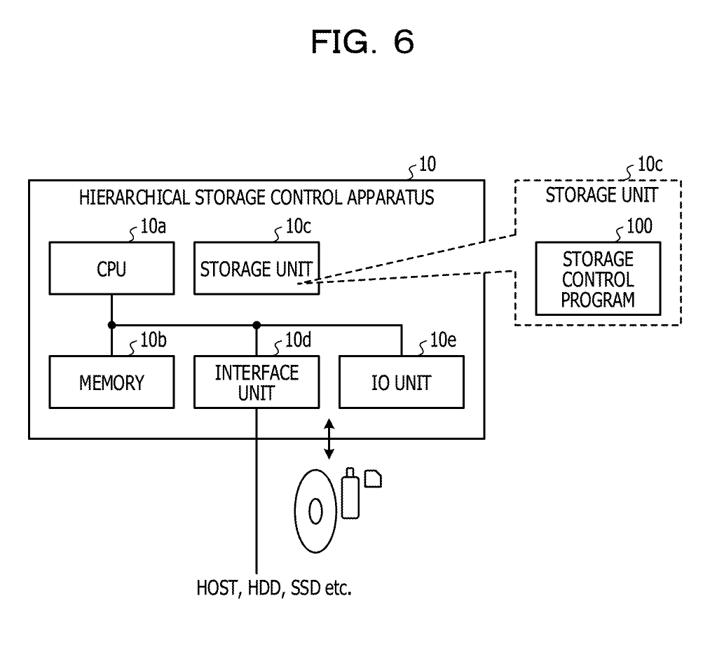

The hierarchical manager 11 has functions of, for example, a data collection unit 11a, an analysis unit 11b, a migration instruction unit 11c, and an information notification unit 11d. These functions may be implemented by using a storage control program 100 (see FIG. 6) run by a central processing unit (CPU) 10a (see FIG. 6) of the hierarchical storage control apparatus 10.

The data collection unit 11a, for example, performs, at predetermined intervals (for example, one minute intervals), collection and aggregation of IO information traced by using blktrace. The data collection unit 11a may store as an access log the aggregation result in, for example, a database not illustrated in the drawings.

The aggregation of IO information performed by the data collection unit 11a may include the aggregation of, for example, information for identifying a particular segment and the number of corresponding IOs with respect to each segment in accordance with the collected IO information.

The analysis unit 11b selects, in accordance with the IO access information collected by the data collection unit 11a, a logical unit of a sub-LUN in the SSD 20 or the HDD 30 from which data is to be migrated and notify the migration instruction unit 11c of information on the selected logical unit of the sub-LUN.

For example, the analysis unit 11b successively extracts, as a segment from which data is migrated to the SSD 20, a segment having the greatest number of IOs until the total number of extracted segments reaches a maximum segment number (a predetermined number) of segments for which the hierarchical migration is performed at one time.

The extraction of a segment performed by the analysis unit 11b may include the extraction of a segment having the number of IOs or an access concentration rate (a ratio of the number of IOs to the total number of IOs) greater than a predetermined threshold. Furthermore, the extraction of a segment may also include the extraction, as a segment from which data is migrated to the HDD 30, for example, of a segment in the SSD 20 having the number of IOs not enough to be included in the predetermined number of segments or having the number of IOs or the access concentration rate equal to or less than the predetermined threshold.

Moreover, the extraction of a segment may also include the execution, as a segment from which data is migrated to the SSD 20 or the HDD 30, of a segment that satisfies, successive times equal to or more than a predetermined number of times, any of the criteria described above for extracting a segment from which data is migrated to the SSD 20 or the HDD 30. In addition to the number of IOs and other criteria described above, a read/write ratio may be used as a criterion for selecting a segment.

As described above, the analysis unit 11b is able to specify the area of the HDD 30 where the IO access concentration occurs. Hereinafter, the area where the IO access concentration occurs in the HDD 30 is also referred to as the IO access concentration area. The IO access concentration area is specified by using, for example, the logical block addressing (LBA).

The function of the analysis unit 11b is not limited to the function described above and various modified functions may be implemented as functions of the analysis unit 11b.

The migration instruction unit 11c instructs, in accordance with the instruction issued by the analysis unit 11b, the cache driver 12 to migrate the data in the selected segment from the HDD 30 to the SSD 20 or from the SSD 20 to the HDD 30. The migration instruction unit 11c notifies the cache driver 12 (a hierarchical control unit 123) of the IO access concentration area.

The migration instruction issued by the migration instruction unit 11c may include instructing migration of data with respect to each segment after converting the offset of the selected segment in the storage volume to the offset in the HDD 30. For example, when the sector size in the HDD 30 is 512 bytes and the offset in the storage volume is 1 GB, the offset in the HDD 30 is: 1×1024×1024×1024/512=2097152.

The information notification unit 11d notifies the cache driver 12 of information a to f as follows:
a: the LBA range that indicates the range of the IO access concentration area,
b: the duration of IO access concentration in the IO access concentration area,
c: the estimated subsequent duration of IO access concentration in the IO access concentration area,
d: the ratio of the number of IO accesses in the IO access concentration area to the total number of IO accesses,
e: the amount of increased response time per IO access when relocating data, and
f: the amount of decreased response time per IO access after relocating data.

Among these kinds of information, for example, the information a to d may be calculated in accordance with the information collected by the data collection unit 11a. The information e and f may be each a time measured by a driver of the OS and then obtained via the data collection unit 11a.

These kinds of information a to f are used for IO access concentration determination performed by an IO access concentration determination unit 124 in the cache driver 12 as described later.

The cache driver 12 controls the data access to the SSD 20 and the HDD 30. The cache driver 12 has a function of dynamic hierarchical control in which the data of a segment under a high load condition is migrated from the HDD 30 to the tiering SSD 20 and a function of caching control in which the SSD 20 is used as the cache of the HDD 30.

As illustrated in FIG. 1, the cache driver 12 includes, for example, a caching control unit 121, a free page management unit 122, the hierarchical control unit 123, the IO access concentration determination unit 124, and a dispatcher 125.

The free page management unit 122 manages the storage area of the SSD 20 with respect to each page unit. The page is a unit storage area of a predetermined size (for example, 4 kilobyte (KB)) used for managing the storage area of the SSD 20.

For example, the free page management unit 122 divides the storage area of the SSD 20 into multiple pages and manages the usage conditions of the pages. The free page management unit 122 manages, for example, whether a particular page of the SSD 20 is in use or unused, with respect to each page. Hereinafter, an unused page (a page in which no data is stored) is also referred to as a free page.

The free page management unit 122 also allocates a free page of the storage area of the SSD 20 to the data targeted by an IO access in response to a request (an allocation request) from the caching control unit 121 or the hierarchical control unit 123.

For example, the hierarchical control unit 123 described later notifies the free page management unit 122 of an allocation request for a free page and the size of the IO access concentration area. The free page management unit 122 searches for a particular number of free pages enough to be used for performing a staging operation for all units of data in the IO access concentration area in accordance with the size of the IO access concentration area that has been reported by the hierarchical control unit 123, allocates the particular number of free pages to the units of data, and notifies the hierarchical control unit 123 of information for identifying the allocated pages. It is preferable that the free page management unit 122 allocate, to the data in the IO access concentration area, a group of multiple contiguous pages as free pages for storing the data.

Furthermore, for example, the caching control unit 121 described later notifies the free page management unit 122 of an allocation request for a free page and the size of data targeted for caching. The free page management unit 122 searches for a particular number of free pages enough to be used for storing the data targeted for caching in accordance with the data size that has been reported by the caching control unit 121, allocates the particular number of free pages to the data, and notifies the caching control unit 121 of information for identifying the allocated pages. It is preferable that the free page management unit 122 allocate, to the data to be cached, a group of multiple contiguous pages as free pages for storing the data.

Consequently, the free page management unit 122 achieves both the management of free pages used for the caching control performed by the caching control unit 121 and the management of free pages used for the dynamic hierarchical control performed by the hierarchical control unit 123. In such a manner, the free page management unit 122 allocates the storage area of the SSD 20 to data dynamically for the purpose of the caching control or the dynamic hierarchical control.

The hierarchical control unit 123 performs the dynamic hierarchical control in which the area for data with lower access frequency is allocated in the HDD 30 whereas the area for data with higher access frequency is allocated in the SSD 20.

The hierarchical control unit 123, for example, receives from the hierarchical manager 11 (the migration instruction unit 11c) an migration instruction in relation to a segment between the HDD 30 and the SSD 20 and migrates the data corresponding to the segment between the SSD 20 and the HDD 30 in accordance with the migration instruction. The data migration in the dynamic hierarchical control is performed with respect to each sub-LUN unit (for example, 1 GB unit).

It is noted that the hierarchical control unit 123 is able to perform the migration in relation to a segment between the HDD 30 and the SSD 20 by employing a known technology, and the description thereof is omitted.

The hierarchical control unit 123 obtains from the free page management unit 122 information on a particular number of free pages enough to be used for performing a staging operation for all units of data in the IO access concentration area of the HDD 30.

The hierarchical control unit 123 includes a hierarchical control queue 129. The hierarchical control queue 129 is used for managing a page allocated by the free page management unit 122 with regard to the IO access concentration area (the LBA range). The hierarchical control queue 129 is implemented by using a memory 10b (see FIG. 6).

The hierarchical control unit 123 obtains from the free page management unit 122 information on the allocated SSD capacity to be used.

The caching control unit 121 performs control for using the cache SSD 20 as the cache of the HDD 30. For example, when the host device performs an IO access to a given area of the HDD 30, the caching control unit 121 stores in the cache SSD 20 a copy of the data in the given area of the HDD 30.

The caching control unit 121 includes a cache table 126 and a cache queue 127.

When the IO access concentration does not occur in the HDD 30, the caching control unit 121 uses the entire storage area of the SSD 20.

The cache table 126 is related to a caching function and indicates information on cache data stored in the cache SSD 20.

The cache table 126 is referred to by the dispatcher 125 described later when the dispatcher 125 receives a data read/write request in an IO access and accordingly determines whether the data targeted by the request exists in the cache SSD 20.

It is noted that the cache table 126 is implemented by employing a known technology, and the description thereof is omitted.

When an IO access to the HDD 30 is performed, the caching control unit 121 stores in the cache SSD 20 a copy of data targeted by the IO access. In response to the caching of data, the caching control unit 121 updates the cache table 126. The caching function is implemented by employing a known technology, and the description thereof is omitted.

The caching control unit 121 replaces data in the cache SSD 20 by employing a replacement algorithm, such as the least recently used (LRU) scheme or the first in, first out (FIFO) scheme. The data replacement in the cache SSD 20 is implemented by employing a known technology, the description thereof is omitted.

The cache queue 127 is related to the caching function and data to be cached (stored) in the cache SSD 20 is recorded as a queue entry in the cache queue 127.

In the cache queue 127, data is stored (queued) with respect to each page unit.

The IO access concentration determination unit 124 determines whether to move to the dynamic hierarchical control mode when the IO access concentration occurs in the HDD 30 while operating in the caching control mode.

The IO access concentration determination unit 124 determines the projected effect on the reduction of IO access response time by comparing the case of continuing the caching control and the case of moving to and performing the dynamic hierarchical control. The IO access concentration determination unit 124 compares the projected result in the case of performing the dynamic hierarchical control including overhead during the data relocation to the tiering SSD 20 and the projected result in the case of continuing the caching control.

The overhead denotes an increased IO access response time to be spent when migrating data in the IO access concentration area of the HDD 30 to the storage area of the SSD 20.

The IO access concentration determination unit 124 performs determination by using the information a to f obtained from the hierarchical manager 11.

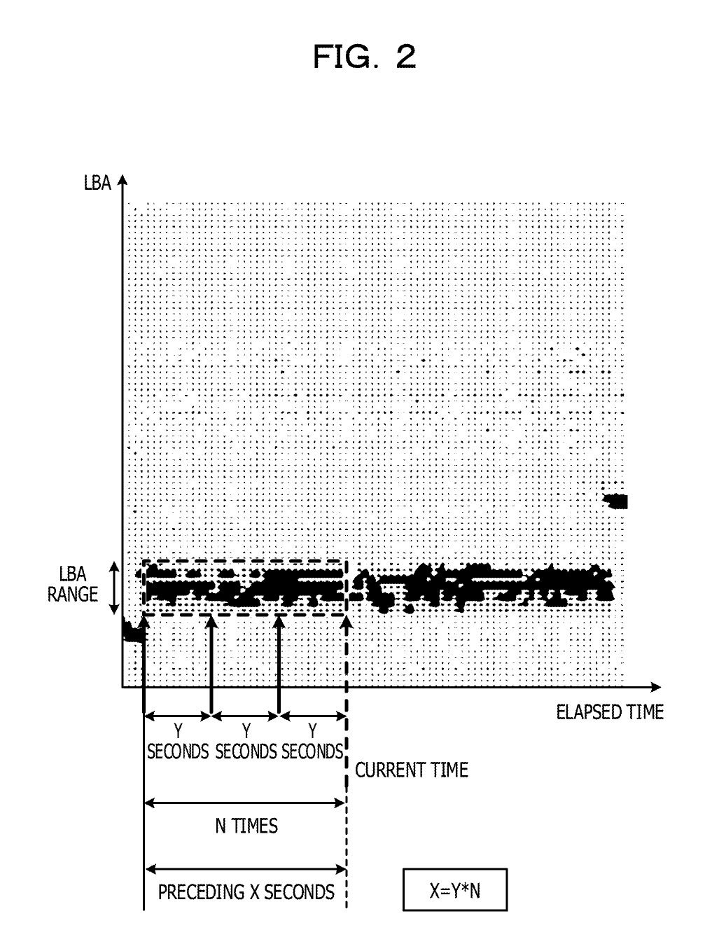

FIG. 2 illustrates an IO access concentration state in the storage area of the HDD 30 and is used for describing processing performed by the IO access concentration determination unit 124 of the hierarchical storage system 1 as an example of the embodiment.

In FIG. 2, the location specified by using the LBA where an IO access occurs is indicated on the vertical axis, the elapsed time is indicated on the horizontal axis, and each IO access is indicated by a black dot.

In FIG. 2, the IO access concentration area over X seconds before a time (current time) t is indicated by a enclosing dashed-line rectangle.

The IO access concentration determination unit 124 obtains an access ratio (a hit rate) of the SSD 20 in the caching control and the number of cached pages with regard to the IO access concentration over X seconds.

For the purpose of simplifying the processing, the hierarchical storage system 1 counts the number of IO accesses N times at Y-second intervals over X seconds before the time (current time) t as illustrated in FIG. 2. Accordingly, during the period of X seconds before the time (current time) t, the information of the number of IO accesses counted each time of the N times at Y-second intervals is stored, where X=Y×N.

The N times is obtained by dividing the time X by Y. Obtaining N is also expressed as rounding X by a multiple of Y, where N=g. Additionally, the time X is also referred to as a time b.

Counting IO accesses every time an IO access occurs is usually complex processing due to a huge amount of information. In contrast, the hierarchical storage system 1 employs simple processing of counting IO accesses collectively with respect to each sub-LUN unit.

The IO access concentration determination unit 124 includes a bitmap counter 128.

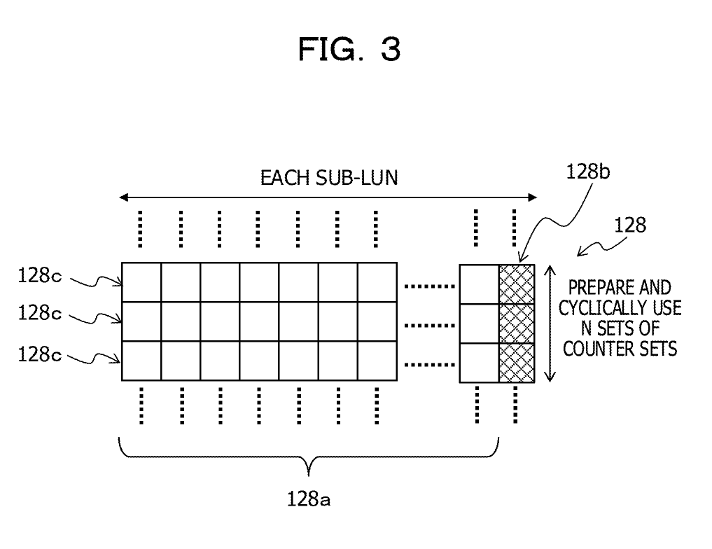

FIG. 3 exemplifies the bitmap counter 128 of the hierarchical storage system 1 as an example of the embodiment.

The bitmap counter 128 counts the number of cache hits per sub-LUN in the HDD 30. The bitmap counter 128 illustrated in FIG. 3 is constituted by multiple counters 128a that each correspond to a sub-LUN unit and that are aligned in the horizontal direction (the lateral direction).

When a cache hit relating to an IO access from the host device occurs in the cache SSD 20, the counter 128a of a sub-LUN corresponding to the destination of the IO access counts the IO access as a count value. The IO access concentration determination unit 124, for example, specifies, by using the LBA, a sub-LUN corresponding to a page with regard to which the cache hit of the IO access from the host device occurs and increments by 1 the total count value of the counter 128a corresponding to the sub-LUN.

The bitmap counter 128 also includes counters (all IO access counters) 128b that each count up IO accesses every time an IO access occurs regardless of whether a cache hit occurs. The bitmap counter 128 illustrated in FIG. 3 includes the all IO access counters 128b at its right end. In the following description, the combination of the multiple counters 128a and a single all IO access counter 128b is also referred to as a counter set 128c.

N sets of the counter sets 128c are included in the bitmap counter 128 and the counter set 128c is cyclically changed to the subsequent counter set 128c at Y-second intervals. In the example illustrated in FIG. 3, three (N=3) counter sets 128c are arranged in the vertical direction. The multiple counter sets 128c correctively denote the history of IO accesses from the host device.

The IO access concentration determination unit 124 calculates a ratio (an IO access ratio) of the number of IO accesses to the IO access concentration area to the total number of IO accesses by using the bitmap counter 128; in other words, the IO access concentration determination unit 124 obtains the IO access condition in the IO access concentration area with respect to total IO accesses to the HDD 30.

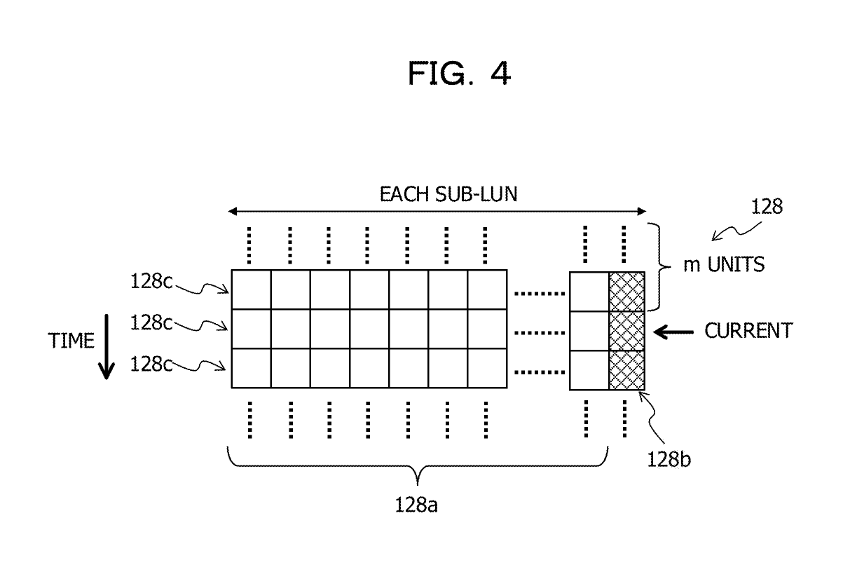

FIG. 4 is a diagram for describing processing performed by the IO access concentration determination unit 124 of the hierarchical storage system 1 as an example of the embodiment.

The IO access concentration determination unit 124 refers to the bitmap counter 128 and calculates a ratio (an IO-access-concentration-area access ratio) of IO accesses that has occurred in the area from LBA_start to LBA_end for Y×m seconds before the current time Current with respect to total IO accesses.

LBA_start denotes the start location of the IO access concentration area and LBA_end denotes the end location of the IO access concentration area.

The IO access concentration determination unit 124 refers to the bitmap counter 128 and obtains and adds count values of the respective counters 128a that correspond to the area from LBA_start to LBA_end and that are included in m units (m sets) of the counter sets 128c before the counter set 128c corresponding to the current time Current, that is, m units of the preceding counter sets 128c. The total value of the number of IO accesses of cache hits is expressed as α.

The IO access concentration determination unit 124 also obtains and adds count values of the respective all IO access counters 128b that are included in the m units (m sets) of the counter sets 128c before the counter set 128c corresponding to the current time Current, that is, the m units of the preceding counter sets 128c. The total value of the number of all IO accesses is expressed as β.

The IO access concentration determination unit 124 calculates the IO-access-concentration-area access ratio γ by using the following equation (1).

IO-access-concentration-area access ratio γ=α×100/β (1)

The IO-access-concentration-area access ratio γ is said as the hit rate in the IO access concentration area.

Additionally, the IO access concentration determination unit 124 manages sub-LUNs corresponding to pages inserted in the cache queue 127 by using sub-LUN caching information 130.

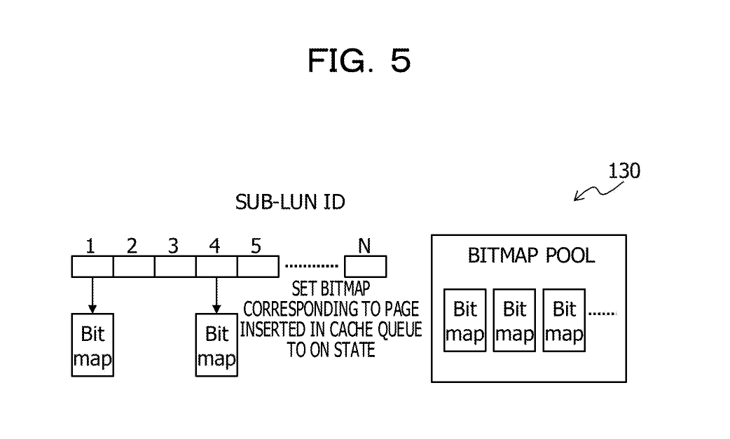

FIG. 5 exemplifies the sub-LUN caching information 130 of the hierarchical storage system 1 as an example of the embodiment.

In the sub-LUN caching information 130, a bitmap is provided in association with each sub-LUN in the HDD 30.

The bitmap may be managed in a bitmap pool. Each bitmap is set to an ON state or an OFF state. For example, a bitmap of a sub-LUN corresponding to the LBA of a page inserted in the cache queue 127 is set to the ON state. By contrast, a bitmap of a sub-LUN corresponding to the LBA of a page deleted from the cache queue 127 is set to the OFF state.

The IO access concentration determination unit 124 specifies a sub-LUN corresponding to the LBA of a page inserted in the cache queue 127 and sets the bitmap associated with the specified sub-LUN to the ON state. When a particular page is deleted from the cache queue 127, the IO access concentration determination unit 124 sets to the OFF state the bitmap of a sub-LUN corresponding to the LBA of the particular page. Setting a bitmap to the OFF state is said as bitmap OFF.

When the data size of a logical unit of a sub-LUN is 1 GB and the page size is 4 KB, the size of a bitmap is 32 KB.

The IO access concentration determination unit 124 determines whether the dynamic hierarchical control or the caching control is to be used to process each IO access request from the host device, that is, performs the dividing operation.

An outline of the determination method employed by the IO access concentration determination unit 124 is described below.

Firstly, in the hierarchical storage system 1, the IO access concentration determination unit 124 obtains, by rounding the IO access concentration duration X (=b) by a multiple of Y, the number of times g indicating how many times the information of the number of IO accesses is stored. The number of times g denotes the number of times the information of the number of IO accesses is stored over the IO access concentration duration X (=b).

The IO access concentration determination unit 124 calculates the ratio of IO accesses having occurred in an IO access concentration area a while having stored data recent g times. The IO access concentration determination unit 124 further calculates the number of pages to be used to migrate the remainder of the IO access concentration area a to the SSD 20.

The IO access concentration determination unit 124 calculates the IO-access-concentration-area access ratio γ in accordance with equation (1) described above. The IO-access-concentration-area access ratio γ is also expressed as h (γ=h).

The IO access concentration determination unit 124 also obtains the number of pages to be relocated (the number of remaining pages to be used) by calculating the number of bitmaps in the OFF state in the sub-LUN caching information 130. The number of remaining pages to be used is expressed as i.

The IO access concentration determination unit 124 estimates, by using the information c, d, e, f, and i described above, an effect (a projected effect) in a case of relocating the data in the entire IO access concentration area, in other words, in a case of performing the dynamic hierarchical control. The estimated effect is expressed as j.

In this embodiment, the shortened response time (the reduced time) is used for representing the effect (the projected effect).

<Effect Estimation of Dynamic Hierarchical Control>

The IO access concentration determination unit 124 calculates (simulates or estimates) an effect (a first projected effect) caused by performing the dynamic hierarchical control of data in the IO access concentration area by using the following equation (2).

j=(c−EE1×i)×f×d−EE1×i×e (2)

In this equation, EE1 is a time (overhead) to be used for relocating one page of data between HDD 30 and the SSD 20. EE1 may be determined as a preset value based on experience or determined by measuring the time while operating the hierarchical storage system 1.

EE1×i is a time (overhead) to be used for relocating data having been not relocated in the IO access concentration area. Since only IO accesses of cache hits contribute to the effect of reducing response time, c−EE1×i is multiplied by d, which is the ratio of the number of IO accesses in the IO access concentration area to the total number of IO accesses.

On the other hand, the reduction in response time in the case of relocating data occurs with regard to all IO accesses, EE1×i×e, which is subtracted in the equation, is not multiplied by d.

<Effect Estimation of Caching Control>

Furthermore, the IO access concentration determination unit 124 calculates (simulates or estimates) an effect (a second projected effect) k caused by performing the caching control by using the information h and f.

Specifically, the IO access concentration determination unit 124 calculates the effect k caused by performing the caching control by using the following equation (3).

k=c×h×f (3)

In this equation, c is the estimated subsequent duration of the IO access concentration in the IO access concentration area, h is the IO-access-concentration-area access ratio, and f is the amount of decreased response time per IO access after relocating data. Note, it is assumed that the hit rate h in the IO access concentration area remains to be the same rate afterwards.

The IO access concentration determination unit 124 then compares the effect j and the effect k.

As a result, when the IO access concentration determination unit 124 determines that j>k, in other words, the dynamic hierarchical control leads to an effect greater than that of the caching control, the IO access concentration determination unit 124 causes the hierarchical control unit 123 to manage IO accesses in the IO access concentration area.

To be specific, the IO access concentration determination unit 124 obtains information on pages to be used for performing a staging operation for the entire IO access concentration area and inserts the information on the pages in the hierarchical control queue 129.

For example, the IO access concentration determination unit 124 obtains information on a page for storing data in the IO access concentration area a from the cache queue 127. The page of the obtained information is expressed as m.

When the free pages in the cache queue 127 are not enough to store the data, the IO access concentration determination unit 124 obtains information on a free page from the free page management unit 122. The page of the obtained information is expressed as n.

When the free pages including the free pages managed by the free page management unit 122 are still not enough to store the data, the IO access concentration determination unit 124 obtains information on the desired number of pages having lower priority from pages in use in the cache queue 127. The page of the obtained information is expressed as o. The page having lower priority may be a page that is accessed less frequently.

The hierarchical control unit 123 performs the dynamic hierarchical control by transferring to the pages m to o the data that has not been relocated.

The dispatcher 125 processes an IO request issued by the host device. Specifically, the dispatcher 125 dispatches an IO request to one of the SSD drivers 13a and 13b, and the HDD driver 14.

The dispatcher 125 determines the destination of the IO request by referring to a hierarchical table of the hierarchical control unit 123 and the cache table 126 of the caching control unit 121.

By the dispatcher 125 dispatching the IO request to the HDD driver 14, the IO request is issued to the HDD 30. By the dispatcher 125 dispatching the IO request to the SSD driver 13a, the IO request is issued to the tiering SSD 20. By the dispatcher 125 dispatching the IO request to the SSD driver 13b, an IO request is issued to the cache SSD 20.

The dispatcher 125, for example, refers to the hierarchical table of the hierarchical control unit 123, and when the access destination of the IO request is set in the hierarchical table, dispatches the IO request to the SSD driver 13a and returns an IO response from the SSD driver 13a to the host device.

Similarly, the dispatcher 125 refers to the cache table 126 of the caching control unit 121, and when the access destination of the IO request is set in the cache table 126, dispatches the IO request to the SSD driver 13b and returns an IO response from the SSD driver 13b to the host device.

When the access destination of the IO request is set in neither the hierarchical table of the hierarchical control unit 123 nor the cache table 126 of the caching control unit 121, the dispatcher 125 dispatches the IO request to the HDD driver 14. The dispatcher 125 also returns an IO response from the HDD driver 14 to the host device.

<A-2. Hardware Configuration Example of Hierarchical Storage Control Apparatus>

Referring to FIG. 6, an example of a hardware configuration of the hierarchical storage control apparatus 10 illustrated in FIG. 1 is described. As illustrated in FIG. 6, the hierarchical storage control apparatus 10 includes, for example, the CPU 10a, the memory 10b, a storage unit 10c, and an interface unit 10d, and an IO unit 10e.

The CPU 10a is an example of a processor that performs various control and other operations. The CPU 10a may be connected to the blocks in the hierarchical storage control apparatus 10 via a bus so as to communicate with each other. As the processor, an electronic circuit, for example, an integrated circuit (IC), such as a micro processing unit (MPU) may be used instead of the CPU 10a.

The memory 10b is an example of a hardware device that stores various kinds of data and programs. At least one of the hierarchical control queue 129, the bitmap counter 128, the cache table 126, and the cache queue 127, which are illustrated in FIG. 1, may be implemented by using the storage area of the memory 10b. Examples of the memory 10b include a volatile memory, such as a random access memory (RAM).

The storage unit 10c is an example of a hardware device that stores, for example, various kinds of data and programs. Examples of the storage unit 10c include various types of storage devices, for example, a magnetic disk drive, such as a HDD, a semiconductor drive, such as a SSD, and a non-volatile memory, such as a flash memory and a read only memory (ROM).

The storage unit 10c may store, for example, the storage control program 100 that implements some or all functions of the hierarchical storage control apparatus 10. In this case, the CPU 10a loads in the memory 10b the storage control program 100 stored in the storage unit 10c and runs the storage control program 100, as a result, some or all functions of the hierarchical storage control apparatus 10 are implemented.

The interface unit 10d is an example of a communication interface that performs, for example, connection and communication control with the SSD 20, the HDD 30, the host device not illustrated in the drawings, and/or a terminal for operators. For example, the interface unit 10d may include various kinds of controllers, an adapter for connecting a device, and a reading unit that reads data and a program that are recorded in a storage medium 10f. The controller may include, for example, an IO controller (IOC) that controls communication with the SSD 20 and the HDD 30. The adapter may include, for example, a device adapter (DA) that connects the SSD 20 and the HDD 30 to the interface unit 10d and a channel adapter (CA) that connects the host device to the interface unit 10d. Examples of the CA include a CA compliant with, for example, local area network (LAN) standards, storage area network (SAN) standards, fibre channel (FC) standards, or InfiniBand standards.

The reading unit may include a connection terminal or a connection device to which the storage medium 10f that is a computer-readable medium is connected or inserted. Examples of the reading unit include an adapter compliant with Universal Serial Bus (USB) standards, an driver that is used for accessing a recording disk, and a card reader that is used for accessing a flash memory, such as a secure digital (SD) card. The storage medium 10f may store the storage control program 100.

The IO unit 10e may include at least one of a mouse, a keyboard, an input unit, such as an operating button, and an output unit, such as a display. For example, the input unit may be used by a user or an operator for performing operations, such as registering and changing settings, selecting (switching) a system mode, and inputting data. The output unit may be used for checking settings by an operator or outputting various kinds of notifications.

It is noted that the hardware configuration of the hierarchical storage control apparatus 10 described above is a mere example. Accordingly, in the hierarchical storage control apparatus 10, various modifications, such as increasing or decreasing hardware devices (for example, adding or excluding a block), dividing hardware devices, combining hardware devices into a given combination, adding or omitting a bus may be made as appropriate.

<B. Operation>

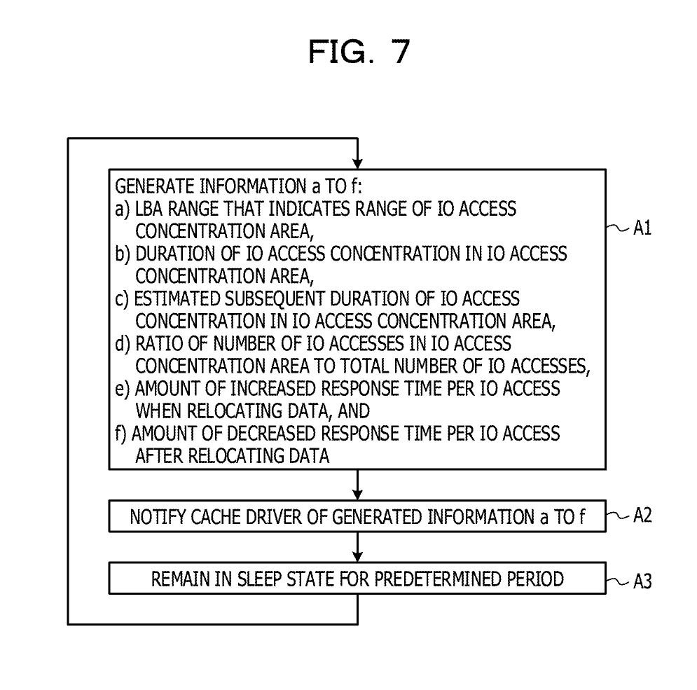

The processing performed by the hierarchical manager 11 of the hierarchical storage system 1 as an example of the embodiment configured as above is described with reference to a flowchart (step A1 to A3) illustrated in FIG. 7.

In step A1, the hierarchical manager 11 generates the information a to f: the information a is the LBA range that indicates the range of the IO access concentration area; the information b is the duration of the IO access concentration in the IO access concentration area; the information c is the estimated subsequent duration of the IO access concentration in the IO access concentration area; the information d is the ratio of the number of IO accesses in the IO access concentration area to the total number of IO accesses; the information e is the amount of increased response time per IO access when relocating data; and the information f is the amount of decreased response time per IO access after relocating data.

In step A2, the hierarchical manager 11 notifies the cache driver 12 of the information a to f generated in step A1.

In step A3, the hierarchical manager 11 enters a waiting state (a sleep state) and remains in the waiting state until a certain time has elapsed. The process then returns to step A1.

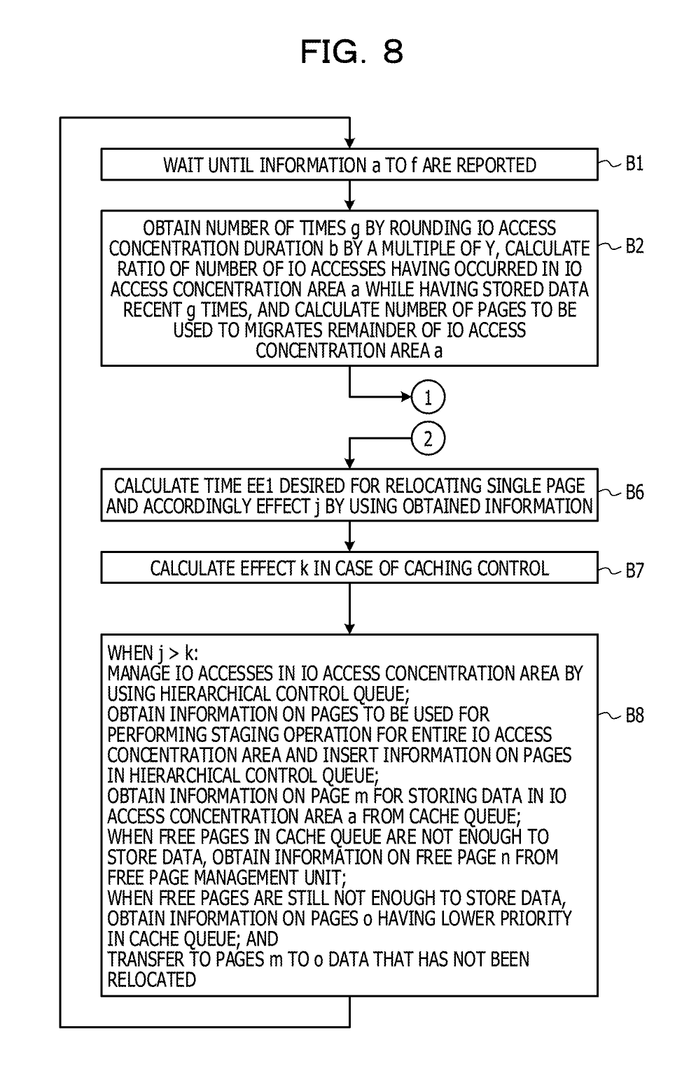

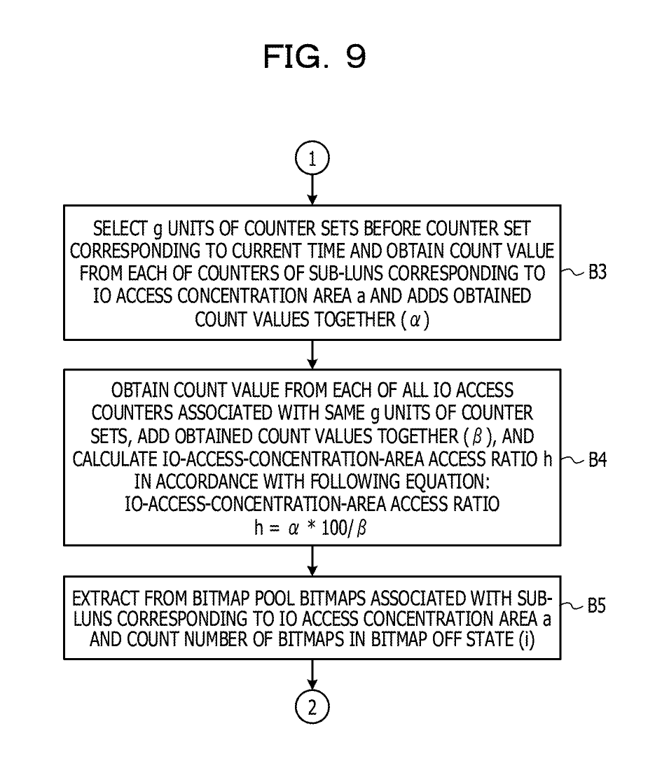

Next, referring to FIGS. 8 and 9, the processing performed by the IO access concentration determination unit 124 of the cache driver 12 of the hierarchical storage system 1 as an example of the embodiment is described. FIG. 8 illustrates the processing of steps B1, B2, B6 to B8 and FIG. 9 illustrates the processing of steps B3 to B5.

In step B1 in FIG. 8, the IO access concentration determination unit 124 waits until the hierarchical manager 11 reports the information a to f.

In step B2 in FIG. 8, the IO access concentration determination unit 124 obtains the number of times g, which indicates how many times the information of the number of IO accesses is stored, by rounding the IO access concentration duration b (=X) by a multiple of Y.

The IO access concentration determination unit 124 also calculates the ratio of the number of IO accesses having occurred in the IO access concentration area a while having stored data recent g times. The IO access concentration determination unit 124 further calculates the number of pages to be used to migrates the remainder of the IO access concentration area a to the SSD 20. Subsequently, the process proceeds to step B3 in FIG. 9.

In step B3, the IO access concentration determination unit 124 refers to the bitmap counter 128 and selects g units (g times units) of the counter sets 128c before the counter set 128c corresponding to the current time Current. The IO access concentration determination unit 124 obtains a count value from each of the counters 128a of sub-LUNs corresponding to the IO access concentration area a and adds the obtained count values together. The total value is expressed as α.

In step B4 in FIG. 9, the IO access concentration determination unit 124 obtains a count value from each of the all IO access counters 128b associated with the g units of the counter sets 128c identical to the counter sets 128c selected in step B3 and adds the obtained count values together. The total value is expressed as β.

The IO access concentration determination unit 124 also calculates the IO-access-concentration-area access ratio h in accordance with equation (1) described above.

In step B5 in FIG. 9, the IO access concentration determination unit 124 refers to the sub-LUN caching information 130, extracts from the bitmap pool bitmaps associated with the sub-LUNs corresponding to the IO access concentration area a, and counts the number of bitmaps in a bitmap OFF state. The counted total number of bitmaps in the bitmap OFF state is expressed as i.

The number of bitmaps i indicates the number of subsequent free pages desired for storing in a memory (the SSD 20) the data in the IO access concentration area.

In step B6 in FIG. 8, the IO access concentration determination unit 124 calculates the time EE1 desired for relocating a single page. Subsequently, by using the obtained information and equation (2) described above, the IO access concentration determination unit 124 calculates the effect j in the case of the dynamic hierarchical control.

In step B7 in FIG. 8, the IO access concentration determination unit 124 calculates the effect k in the case of the caching control by using equation (3) described above.

In step B8 in FIG. 8, when the IO access concentration determination unit 124 determines that j>k, in other words, the dynamic hierarchical control leads to an effect greater than that of the caching control, the IO access concentration determination unit 124 causes the hierarchical control unit 123 to manage IO accesses in the IO access concentration area.

Specifically, the IO access concentration determination unit 124 obtains information on pages to be used for performing a staging operation for the entire IO access concentration area and inserts the information on the pages in the hierarchical control queue 129.

For example, the IO access concentration determination unit 124 obtains information on the page m for storing data in the IO access concentration area a from the cache queue 127.

When the free pages in the cache queue 127 are not enough to store the data, the IO access concentration determination unit 124 obtains information on the free page n from the free page management unit 122.

When the free pages including the free pages managed by the free page management unit 122 are still not enough to store the data, the IO access concentration determination unit 124 obtains information on the desired number of pages o having lower priority from pages in use in the cache queue 127.

The hierarchical control unit 123 performs the dynamic hierarchical control by transferring to the pages m to o the data that has not been relocated.

<C. Advantages>

As described above, in the hierarchical storage system 1 as an example of the present embodiment, the IO access concentration determination unit 124 calculates both the effect j in the case of the dynamic hierarchical control and the effect k in the case of the caching control. When the IO access concentration determination unit 124 determines that the dynamic hierarchical control leads to the effect greater than that of the caching control, the IO access concentration determination unit 124 determines to perform the dynamic hierarchical control with respect to the data in the IO access concentration area by using the SSD 20 as the tier the SSD 20.

By contrast, when the IO access concentration determination unit 124 determines to not perform the dynamic hierarchical control, the caching control is performed instead by using the SSD 20 as the cache SSD 20.

Since the IO access concentration in the HDD 30 does not consistently occur, it is possible to efficiently use the storage area of the SSD 20 by using the SSD 20 as the cache SSD 20 in the case where the dynamic hierarchical control is not performed.

When the IO access concentration determination unit 124 determines that the dynamic hierarchical control does not lead to the effect greater than that of the caching control, the IO access concentration determination unit 124 determines to not perform the dynamic hierarchical control by using the SSD 20 as the tier the SSD 20. As a result, it is possible to reduce the response time with respect to IO requests.

Since the free page management unit 122 manages free pages in a centralized manner to deal with allocation requests from both the hierarchical control unit 123 and the caching control unit 121, it is possible to dynamically allocate the storage area of the SSD 20 for the dynamic hierarchical control or the caching control. This configuration also enables the efficient use of the storage area of the SSD 20.

The hierarchical control unit 123 controls data migration between the HDD 30 and the tier SSD 20 by using a page unit identical to the page unit used for data transfer between the HDD 30 and the cache SSD 20 performed by the caching control unit 121. This configuration facilitates checking of the progress of data migration under the dynamic hierarchical control.

<D. Others>

The disclosed technique is not limited to the embodiment described above and may be implemented by making various modification without departing from the scope of the embodiment.

For example, the technology is not limited to the hierarchical storage system 1 of the embodiment with the use of the HDD 30 and the SSD 20 described above. The technology may be also applied to, for example, a hierarchical memory system with the use of a cache memory and a main memory device. In other words, the present embodiment may be applied to not only the hierarchical memory system including non-volatile storage devices but also the hierarchical memory system including volatile storage devices.

Furthermore, in addition to the HDD 30 and the SSD 20 included in the hierarchical storage system 1 according to the embodiment, the technology may be applied by using storage devices that operate at speeds different from each other. The technology may be applied to, for example, a hierarchical storage system using the SSD 20 and a semiconductor memory that operates at an access speed higher than that of the SSD.

Moreover, the technology may be applied to a hierarchical storage system using, for example, a magnetic storage device with a larger capacity but a lower speed compared to the SSD 20, such as a tape drive, instead of the HDD 30.

Further, in the embodiment, the operation of the hierarchical storage control apparatus 10 is described in conjunction with the single SSD 20 and the single HDD 30, but multiple SSDs 20 and multiple HDDs 30 may be used in the hierarchical storage system 1 in the same manner.

Furthermore, The functional blocks of the hierarchical storage control apparatus 10 illustrated in FIG. 1 may be combined into any combinations or further divided into any forms. For example, in the flowcharts illustrated in FIGS. 8 and 9, the processes of steps B3 to B5 in FIG. 9 may be performed by a processing unit other than the IO access concentration determination unit 124.

Moreover, the present embodiment is not limited to the application to the hierarchical storage system in the example described above but may be applied to the case in which the first storage device such as the SSD is a cache memory in the same manner as that of the above example. This case also achieves the same advantages as that of the above example.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An apparatus for data migration between a first storage device and a second storage device whose performance is different from that of the first storage device, the apparatus comprising:
a memory; and
a processor coupled to the memory, the processor being configured to
execute comparison processing that includes comparing a first projected effect in a case of migrating data in an access concentration area of the second storage device to the first storage device and a second projected effect in a case of storing in the first storage device a copy of data in the second storage device and using the copy of data as cached data without migrating the data, and
execute determination processing that includes determining to migrate data in a first area of the second storage device to the first storage device when the first projected effect is greater than the second projected effect, the first area being the access concentration area of the second storage device.

2. The apparatus according to claim 1, wherein
the processor is configured to execute data transfer processing that includes
transferring the copy of data from the second storage device to the first storage device with respect to a page unit of a predetermined data size, and
managing, with respect to the page unit, the migrating of the data from the first area of the second storage device to the first storage device.

3. The apparatus according to claim 2, wherein
the data transfer processing is configured to
obtain information on a particular number of pages equivalent to a first data amount, the first data amount indicating a total amount of data that is included in the data in the first area and that has not been migrated from the second storage device to the first storage device, and
set the obtained information on the pages in a first queue, the first queue being a queue used for managing data migration from the second storage device to the first storage device.

4. The apparatus according to claim 1, wherein the comparison processing is configured to calculate the first projected effect by using overhead caused by migrating a page unit of data from the second storage device to the first storage device, estimated subsequent duration in the access concentration area, a ratio of a number of accesses occurred in the access concentration area to a number of all accesses, an amount of increased response time per access when relocating data, and an amount of decreased response time per access after relocating data.

5. The apparatus according to claim 1, wherein the comparison processing is configured to calculate the second projected effect by using estimated subsequent duration in the access concentration area, a ratio of a number of accesses occurred in the access concentration area to a number of all accesses, and an amount of decreased response time per access after relocating data.

6. A method for data migration between a first storage device and a second storage device whose performance is different from that of the first storage device, the method comprising:
executing comparison processing that includes comparing a first projected effect in a case of migrating data in an access concentration area of the second storage device to the first storage device and a second projected effect in a case of storing in the first storage device a copy of data in the second storage device and using the copy of data as cached data without migrating the data, and
executing determination processing that includes determining to migrate data in a first area of the second storage device to the first storage device when the first projected effect is greater than the second projected effect, the first area being the access concentration area of the second storage device.

7. The method according to claim 6, the method further comprising:
executing data transfer processing that includes
transferring the copy of data from the second storage device to the first storage device with respect to a page unit of a predetermined data size, and
managing, with respect to the page unit, the migrating of the data from the first area of the second storage device to the first storage device.

8. The method according to claim 7, wherein
the data transfer processing is configured to
obtain information on a particular number of pages equivalent to a first data amount, the first data amount indicating a total amount of data that is included in the data in the first area and that has not been migrated from the second storage device to the first storage device, and
set the obtained information on the pages in a first queue, the first queue being a queue used for managing data migration from the second storage device to the first storage device.

9. The method according to claim 6,
wherein the comparison processing is configured to calculate the first projected effect by using overhead caused by migrating a page unit of data from the second storage device to the first storage device, estimated subsequent duration in the access concentration area, a ratio of a number of accesses occurred in the access concentration area to a number of all accesses, an amount of increased response time per access when relocating data, and an amount of decreased response time per access after relocating data.

10. The method according to claim 6,
wherein the comparison processing is configured to calculate the second projected effect by using estimated subsequent duration in the access concentration area, a ratio of a number of accesses occurred in the access concentration area to a number of all accesses, and an amount of decreased response time per access after relocating data.

11. A non-transitory computer-readable storage medium for storing a program which causes a processor to perform processing for data migration between a first storage device and a second storage device whose performance is different from that of the first storage device, the processing comprising:
executing comparison processing that includes comparing a first projected effect in a case of migrating data in an access concentration area of the second storage device to the first storage device and a second projected effect in a case of storing in the first storage device a copy of data in the second storage device and using the copy of data as cached data without migrating the data, and
executing determination processing that includes determining to migrate data in a first area of the second storage device to the first storage device when the first projected effect is greater than the second projected effect, the first area being the access concentration area of the second storage device.

12. The non-transitory computer-readable storage medium according to claim 11, the processing further comprising:
executing data transfer processing that includes
transferring the copy of data from the second storage device to the first storage device with respect to a page unit of a predetermined data size, and
managing, with respect to the page unit, the migrating of the data from the first area of the second storage device to the first storage device.

13. The non-transitory computer-readable storage medium according to claim 12, wherein
the data transfer processing is configured to
obtain information on a particular number of pages equivalent to a first data amount, the first data amount indicating a total amount of data that is included in the data in the first area and that has not been migrated from the second storage device to the first storage device, and
set the obtained information on the pages in a first queue, the first queue being a queue used for managing data migration from the second storage device to the first storage device.

14. The non-transitory computer-readable storage medium according to claim 11,
wherein the comparison processing is configured to calculate the first projected effect by using overhead caused by migrating a page unit of data from the second storage device to the first storage device, estimated subsequent duration in the access concentration area, a ratio of a number of accesses occurred in the access concentration area to a number of all accesses, an amount of increased response time per access when relocating data, and an amount of decreased response time per access after relocating data.

15. The non-transitory computer-readable storage medium according to claim 11,
wherein the comparison processing is configured to calculate the second projected effect by using estimated subsequent duration in the access concentration area, a ratio of a number of accesses occurred in the access concentration area to a number of all accesses, and an amount of decreased response time per access after relocating data.
